(19) United States
(12) Patent Application Publication
(10) Pub. No.: US 2003/0004863 A1
(43) Pub. Date: Jan. 2, 2003

(54) Computer system & method for trading

(76) Inventor: David Trevor Cliff, Bristol (GB)

Correspondence Address: HEWLETT-PACKARD COMPANY, Intellectual Property Administration, P.O. Box 272400, Fort Collins, CO, 80527-2400, US

(21) Appl. No.: 10/179,545

(22) Filed: Jun. 25, 2002

(30) Foreign Application Priority Data
Jun. 30, 2001 (GB) 0116070.4

(51) Int. Cl. G06F 17/60

(52) U.S. Cl. 705/37

(57) ABSTRACT

The present invention provides a computer system (2) for trading, the system (2) comprising a trading locale for establishing a marketplace, a bid receiver (20), an offer receiver (22), a current trading price monitor (26), an equilibrium price calculator (24) for determining whether there is a difference between the equilibrium price (P_{O}) and current trading price (P_{O}) and a trading unit (28) for selling if the equilibrium price (P_{O}) is less than the current price (P_{T}) or for buying if the equilibrium price (P_{O}) is greater than the current price (P_{T}).

The present invention relates to computer systems and methods for trading, which expression includes brokerage.

In a continuous double auction marketplace, for a given item sellers provide offer prices and buyers provide bid prices for a given item. The item may be a physical item or a service. As is well known economic theory, if there is an excess supply, the equilibrium price (P₀), at which supply and demand curves intersect, falls, while if there is an excess demand P₀ rises.

However, in a fluid marketplace there is always a delay, which can vary enormously, between the change in supply and demand altering P₀ and the current trading price for the item (P_{T}) reaching P₀.

Preferred embodiments of the present invention aim to provide an improved computer system and method for trading.

According to the present invention in a first aspect there is provided a computer system for trading, the system comprising a trading locale for establishing a marketplace, a bid receiver, an offer receiver, a current trading price monitor, an equilibrium price calculator for determining whether there is a difference between the equilibrium price and current trading price and a trading unit for selling if the equilibrium price is less than the current price or for buying of the equilibrium price is greater than the current price.

Suitably, the equilibrium price calculator calculates the equilibrium price.

Suitably, the trading unit is activated only if the difference between the equilibrium price and the current trading price is greater than a predetermined amount.

According to the present invention in a second aspect, there is provided a trading method comprising establishing a marketplace, receiving bids and offers, determining whether an equilibrium price differs from a current trading price, selling if the equilibrium prices is less than the current trading price or buying if the equilibrium price is greater than the current trading price.

Suitably, the trading method comprises the additional step of calculating the equilibrium price.

Suitably, in the trading method the buying or selling takes place only if the difference between the equilibrium price and the current trading price is greater than a predetermined amount.

The present invention will now be described, by way of example only, with reference to the drawings that follow; in which:

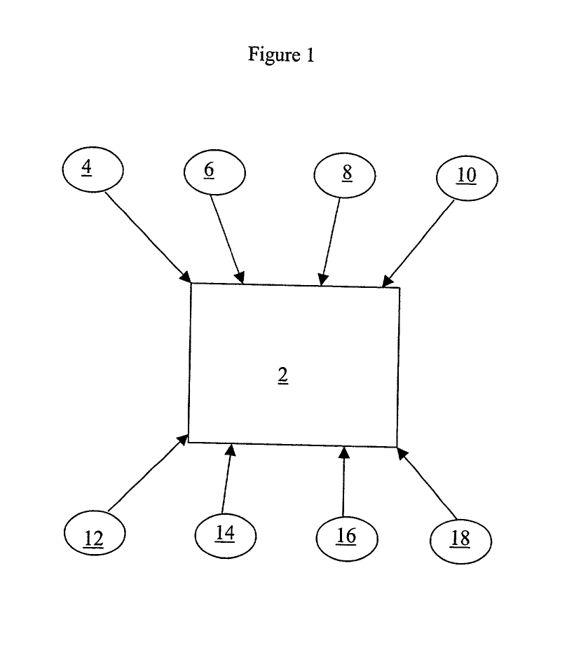

FIG. 1 is a systematic functional diagram of a computer system according to the present invention.

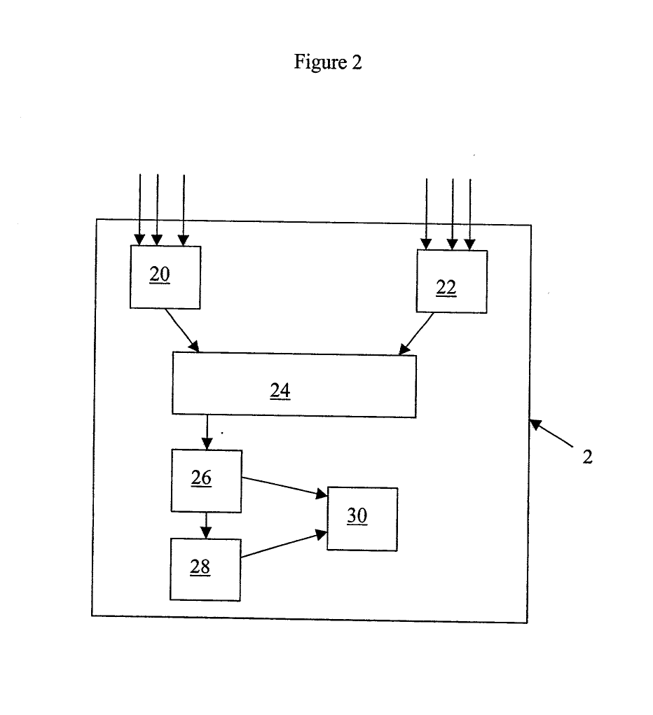

FIG. 2 is a more detailed view of the computer system in FIG. 1.

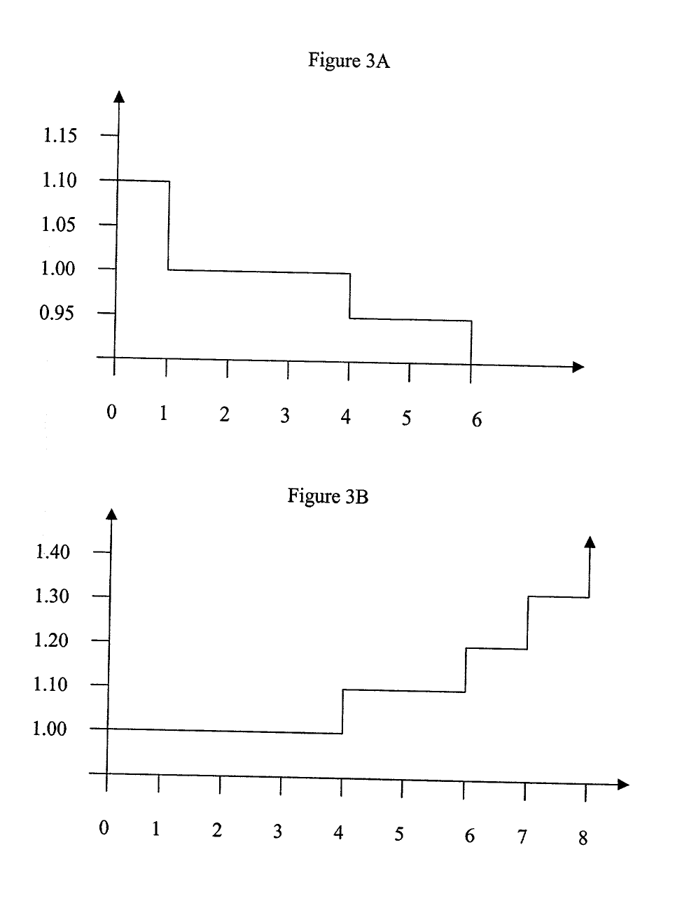

FIGS. 3A and 3B are graphical representations of the supply and demand curves in a continuous double auction marketplace.

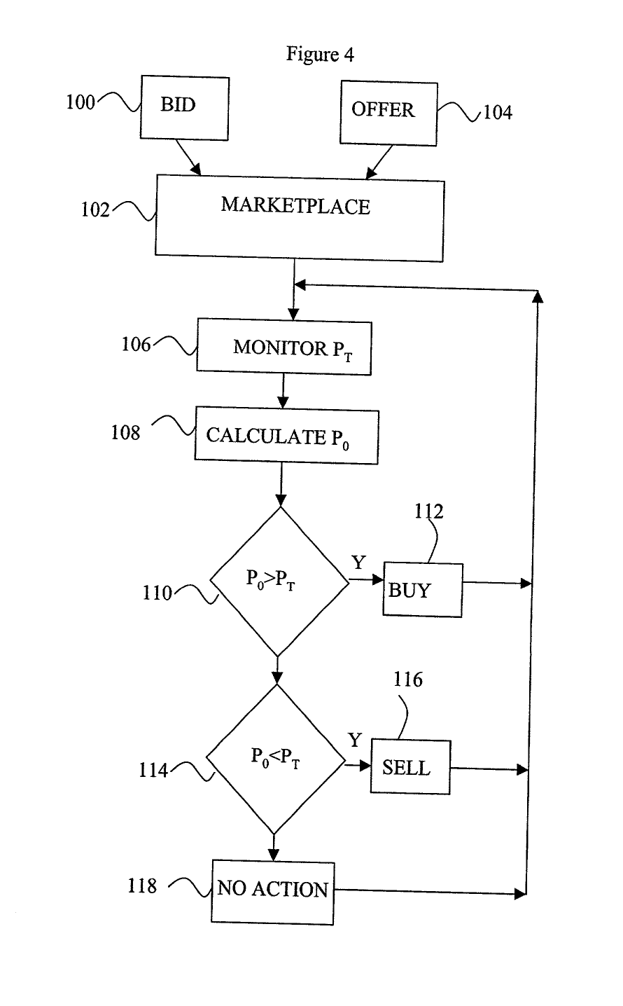

FIG. 4 is a functional flow diagram illustrating operation of an embodiment of the present invention.

Referring to FIG. 1 of the drawings that follow there is shown a computer system 2 configured to receive bids to purchase items from buyers 4, 6, 8, 10 and offers for sale from sellers 12, 14, 16, 18. Typically the computer system 2 is connected to the buyers and sellers across a distributed electronic network such as the internet, a wide area network or local area network. Each buyer and seller comprises an entity communicating with the computer system 2 via a computer node.

Although a limited number of buyers and sellers are shown in FIG. 1 it will be appreciated that a multiplicity of buyers and a multiplicity of sellers may be involved.

Computer system 2 establishes a continuous double auction marketplace for the buying and selling of items. That is a locale is provided at which buyers and sellers can trade on a double auction basis. These items may be property, e.g. physical property, land, stocks, shares etc or services to be traded between buyers and sellers. The owner of the marketplace acts as a broker.

Referring to FIG. 2 of the drawings that follow, the computer system is described in terms of functional units and is shown to comprise a bid receiver 20, an offer receiver 22, an equilibrium price calculator 24 a current trading price determiner 26 and a trading unit 28.

Bid receiver 20 receives purchase offer bids from buyers 4, 6, 8, 10. Offer receiver 22 receives sale offers from sellers 12, 14, 16, 18.

Equilibrium price calculator 24 determines the equilibrium price based on received bids and offers via the bid receiver 20 and offer receiver 22.

By way of example, with reference to FIG. 3 of the drawings that follow, to take a simplistic example FIG. 3A is a graph representing, on the Y axis price and on the X axis quantity of items in relation to buy offers received. The graph shows the case in which three buy offers have been received as follows: buy 3 at 1.00, buy 1 at 1.10 and buy 2 at 0.95.

The graph of FIG. 3A is referred to as the “demand curve” (with sufficient bids the stepped graph becomes graphically a smoother curve but for simplicity is represented here with only three bids).

Referring to FIG. 3B, a “supply curve” is shown with price on the Y axis and quantity on the X axis for the following sell offers: sell 4 at 1.00, sell 1 at 1.30, sell 1 at 1.20, sell 2 at 1.10

The price at which the demand curve and supply curve intersect (here 1.00) determines, according to economic theory, the equilibrium price P₀ at which the item should be traded which is determined in real time by the equilibrium price calculator 24. Typically the equilibrium price calculator 24 will comprise a maths processor for calculating the equilibrium price as quickly as possible dependent upon received bids and offers.

Current trading price determiner 26 monitors the current price in the market at which an item is being sold. This is determined by observation of the trades being made between the buyers and sellers in the marketplace.

Trading unit 28 receives the equilibrium price P₀ and the current price P_{T} from equilibrium price calculator 24 and current price monitor 26, respectively. Trading unit 28 then sells units into the marketplace i.e. offering items for a price below the current trading price P_{T} if the equilibrium price is below P_{T}. The trading unit 28 offers units for sale at a price between the current trading price P_{T} and the equilibrium price P₀, generally as little below the current trading price as possible.

In the case in which the equilibrium price P₀ is greater than the current trading price P_{T} the trading unit 28 purchases units by making bids above the current trading price P_{T}. The bids will be between the current trading price and the equilibrium price P₀ and, preferably, as little above the current trading price P_{T} as possible.

Bids, and offers, both from third parties and the trading unit 28, are made privately.

By the computer system 2 selling or buying as appropriate depends on the difference between the current trading price P_{T} and equilibrium price P₀, the current trading price tends towards the equilibrium price P₀ faster than in the existing markets and as such communicates this information more rapidly to the buyers and sellers (and potential buyers and sellers) monitoring the marketplace.

Further, it is possible for the owner of the computer system to provide the marketplace on a commission free basis to participants (buyers and sellers) because the owner of the market can, based on its knowledge of the sale offers and purchase bids buy and sell items ahead of the market fluctuations to obtain income therefrom. Other participants (or potential participants) in the marketplace may be monitoring the prices in the marketplace but can only respond to price fluctuations, not to bid and offer information as can the computer system 2.

Referring to FIG. 4 of the drawings that follow the method of trading of the present embodiment is described in more detail by a functional flow diagram. The steps referred to in the diagram need not be sequential in the order described. In practice all of the operations will occur substantially simultaneously.

In step 100 bids for purchases are submitted by potential buyers to the marketplace indicated schematically at 102 established by the system 2. In step 104 offers for sale are submitted by potential sellers to the marketplace 102 established by the system 2.

In step 106 the current trading price P_{T} Of the marketplace 102 is monitored as described above.

In step 108 the equilibrium price P₀ of the marketplace 102 is calculated. The equilibrium price P₀ is calculated, so far as is practical, in real time with as much accuracy as possible. However, the present invention can still operate if the equilibrium price is not known precisely, so long as it is known whether, within the margin of error of calculation of the equilibrium price P₀ and monitored current trading price P_{T}, there is a difference between them and the direction of that difference.

In step 110 it is determined whether the equilibrium price P₀ is greater than the current trading price P_{T} (i.e. a rising market), in which case at step 112 the item is purchased.

If the equilibrium price P₀ is not greater than the current trading price P_{T} then at step 114 it is determined whether the equilibrium price P₀ is less than the current trading price P_{T} (i.e. a falling market), in which case the item is sold at step 116.

The amount to be bought or sold is somewhat arbitrary. To maximise the effect on the market, as much as possible can be bought or sold. In the case of buying, the maximum amount is limited by the amount of funds of the purchaser and of the item available. In the case of selling, the maximum is the amount of the item held at that time available for sale.

Another option is for the marketplace controller to agree with the marketplace participants that its buy and sell activities will be restricted to certain volumes and/or amounts.

Following a purchase (step 112) or sale (step 116), the method returns to its monitoring of current trading price P_{T} and calculation of equilibrium price P₀, i.e. return to step 108.

In the case in which the equilibrium price P₀ equals the current trading price P_{T}, no action is taken (step 118) and the method returns to step 108, in effect to await market fluctuations.

To allow for margins of error in the values of the current trading price P_{T} and equilibrium price P₀, the buy and sell operations may be set to only take place in the event of there being a predetermined difference between the two values. The predetermined difference may vary over time and between sell and purchase operations.

Embodiments of the present invention enable faster communication of marketplace equilibrium price fluctuations to marketplace participants by accelerating the movement of the marketplace to the equilibrium price.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer system for trading, the system comprising a trading locale for establishing a marketplace, a bid receiver, an offer receiver, a current trading price monitor, an equilibrium price calculator for determining whether there is a difference between the equilibrium price and current trading price and a trading unit for selling if the equilibrium price is less than the current price or for buying if the equilibrium price is greater than the current price.

2. A computer system according to claim 1, in which the equilibrium price calculator calculates the equilibrium price.

3. A computer system according to claim 2, in which the trading unit is activated only if the difference between the equilibrium price and the current trading price is greater than a predetermined amount.

4. A trading method comprising establishing a marketplace, receiving bids and offers, determining whether an equilibrium price differs from a current trading price, selling if the equilibrium price is less than the current trading price or buying if the equilibrium price is greater than the current trading price.

5. A trading method according to claim 4, which comprises the additional step of calculating the equilibrium price.

6. A trading method according to claim 5, in which the buying or selling takes place only if the difference between the equilibrium price and the current trading price is greater than a predetermined amount.

7. A computer system for trading, substantially as described herein, with reference to and as shown in FIGS. 1 and 2 of the drawings that follow.

8. A trading method substantially as described herein.
